(19) United States
(12) Patent Application Publication
(10) Pub. No.: US 2013/0267260 A1
(43) Pub. Date: Oct. 10, 2013

(54) MAP MODIFICATION USING GROUND-TRUTH MEASUREMENTS

(71) Applicants: Hui Chao, San Jose, CA (US); Sameera Poduri, Santa Clara, CA (US); Rajarshi Gupta, Sunnyvale, CA (US)

(72) Inventors: Hui Chao, San Jose, CA (US); Sameera Poduri, Santa Clara, CA (US); Rajarshi Gupta, Sunnyvale, CA (US)

(73) Assignee: QUALCOMM Incorporated, San Diego, CA (US)

(21) Appl. No.: 13/443,791

(22) Filed: Apr. 10, 2012

(51) Int. Cl. H04W 24/00

(52) U.S. Cl. 455/457

(57) ABSTRACT

Disclosed is a method for receiving a conceptual map of a navigable area, the conceptual map including two or more topological elements being related to one another in the conceptual map by a first set of dimensions; applying one or more ground truth measurements or topological constraints to the first set of dimensions of the conceptual map to provide a modified map having corrected dimensions; and mapping an estimated location of the mobile station to the modified map.

### BACKGROUND

1. Field

The subject matter disclosed herein relates to modifying a conceptual map using one or more constraints related to structures included in the map.

2. Information

GPS and other like satellite positioning systems have enabled navigation services for mobile handsets in outdoor environments. Since satellite signals may not be reliably received or acquired in an indoor environment, different techniques may be employed to enable navigation services. For example, mobile devices may obtain a position fix by measuring ranges to three or more terrestrial wireless access points that are positioned at known locations. Such ranges may be measured, for example, by obtaining a MAC ID address from signals received from such access points and obtaining range measurements to the access points by measuring one or more characteristics of signals received from such access points such as, for example, signal strength and round trip delay.

A navigation system may provide navigation assistance or mapped features to a mobile device as it enters a particular area. For example, mapped features may relate to or otherwise identify certain physical objects, characteristics, or points of interest within a building or complex, etc. Thus, in certain instances, an indoor navigation system may provide a digital electronic map to a mobile device upon entering a particular indoor area, e.g., in response to a request for position assistance data. Such a digital electronic map may show indoor features such as doors, hallways, entry ways, walls, etc., points of interest such as bathrooms, pay phones, room names, stores, etc. A digital electronic map may be stored at a server to be accessible by a mobile device through selection of a URL, for example. By obtaining and displaying a digital electronic map, a mobile device may overlay a current location of a mobile device (and user) over the displayed map to provide the user with additional context, for example.

### BRIEF DESCRIPTION OF THE FIGURES

Non-limiting and non-exhaustive features will be described with reference to the following figures, wherein like reference numerals refer to like parts throughout the various figures.

FIG. 1 shows various dimensions of features of elements represented in a conceptual map of a shopping mall, according to an implementation.

FIG. 2 is a system diagram illustrating certain features of a system containing a mobile station, in accordance with an implementation

FIG. 3 shows a conceptual map of a building complex, according to an implementation.

FIG. 4 shows a portion of a map in an area including a building complex, according to an implementation.

FIG. 5 shows a constraint model of a portion of a building complex, according to an implementation.

FIG. 6 shows constraint elements represented in a conceptual map of a building complex, according to an implementation.

FIGS. 7 and 8 show constraint models of a portion of a building complex, according to other implementations.

FIG. 9 shows constraint elements represented in a conceptual map of a building complex, according to another implementation.

FIG. 10 shows constraint elements in a portion of a map in an area including a building complex, according to an implementation.

FIG. 11 shows a corrected map of a building complex superposed with a map, according to an implementation.

FIG. 12 is a flow diagram illustrating a process for producing a corrected map from a conceptual map, according to an implementation.

FIG. 13 is a schematic block diagram illustrating an exemplary mobile station, in accordance with an implementation.

FIG. 14 is a schematic block diagram of an example computing platform.

### SUMMARY

In some implementations, a method performed at a mobile station may comprise: receiving a conceptual map of a navigable area, wherein the conceptual map may include two or more topological elements being related to one another in the conceptual map by a first set of dimensions; applying one or more ground truth measurements or topological constraints to the first set of dimensions of the conceptual map to provide a modified map having corrected dimensions; and mapping an estimated location of the mobile station to the modified map.

In other implementations, an apparatus may comprise: means for receiving a conceptual map of a navigable area, wherein the conceptual map may include two or more topological elements being related to one another in the conceptual map by a first set of dimensions; means for applying one or more ground truth measurements or topological constraints to the first set of dimensions of the conceptual map to provide a modified map having corrected dimensions; and means for mapping an estimated location of a mobile station to the modified map.

In still other implementations, an apparatus may comprise: memory and one or more processing units to: receive a conceptual map of a navigable area, wherein the conceptual map may include two or more topological elements being related to one another in the conceptual map by a first set of dimensions; apply one or more ground truth measurements or topological constraints to the first set of dimensions of the conceptual map to provide a modified map having corrected dimensions; and map an estimated location of a mobile station to the modified map.

In yet other implementations, an article may comprise: a non-transitory storage medium comprising machine-readable instructions stored thereon that may be executable by a special purpose computing device to: receive a conceptual map of a navigable area, wherein the conceptual map may include two or more topological elements being related to one another in the conceptual map by a first set of dimensions; apply one or more ground truth measurements or topological constraints to the first set of dimensions of the conceptual map to provide a modified map having corrected dimensions; and map an estimated location of a mobile station to the modified map.

### DETAILED DESCRIPTION

Reference throughout this specification to “one example”, “one feature”, “an example” or “one feature” means that a particular feature, structure, or characteristic described in connection with the feature and/or example is included in at least one feature and/or example of claimed subject matter. Thus, the appearances of the phrase “in one example”, “an example”, “in one feature”, or “a feature” in various places throughout this specification are not necessarily all referring to the same feature and/or example. Furthermore, the particular features, structures, or characteristics may be combined in one or more examples and/or features.

In some implementations, a mobile station (MS) may receive navigation assistance data from a navigation system as the MS enters a particular area, which may be indoors or outdoors. Such navigation assistance data may comprise a digital electronic map, for example. For example, a navigation system may comprise an indoor navigation application, which may include one or more maps to show features of indoor structures such as doors, hallways, entry ways, walls, or points of interest (e.g., bathrooms, pay phones, room names, stores). Navigation assistance data may further include, for example, information to facilitate measurements of ranges to wireless access points positioned at known fixed locations. In other applications, a map may show streets, buildings, driveways, and so on.

Digital maps provided as navigation assistance data may vary in accuracy based, at least in part, on the source of the digital map or an overall precision used for making the map. A “conceptual map”, which may be drawn by an artist, for example, may have a relatively inaccurate scale or position while preserving topological relationships between or among elements in the map. A conceptual map may depict a mall, shopping center, downtown area, office space, neighborhood, or any other navigable area, for example. Inaccuracies in a digital map may degrade performance of a navigation system. For example, trajectory estimation processes relying on accuracy of routing constraints set forth by a digital map may not operate properly with inaccurate maps.

In an implementation, a conceptual map may have a scale that varies across the conceptual map for different topological elements, so that some elements may be depicted as “over-sized” while other elements may be depicted as “under-sized”. A conceptual map may include two or more topological elements that are related to one another in the conceptual map by a set of dimensions, as described below. Here, “dimensions” includes lengths, widths, heights, distances, sizes, angles, areas, volumes, and so on. At least some dimensions that relate topological elements in a conceptual map may be incorrect. As described below, applying one or more ground truth measurements or topological constraints to a set of dimensions of a conceptual map may provide a modified map having corrected dimensions. An estimated location of a mobile station may be mapped to such a modified map, for example.

While a conceptual map may correctly describe topological relationships between or among elements depicted in the conceptual map (e.g., buildings, walkways, rooms), dimensions or exact positions of features of the elements may be distorted or incorrect. For example, a ten meter building block may appear to have the same length as a six meter building block. In another example, a sixty degree angle of intersection between different roads or hallways may appear as a 90 degree turn on a conceptual map. According to a particular implementation, a conceptual map may be corrected at an MS based, at least in part, on an application of constraints, which may be inferred from measurements performed externally to the MS. Constraints may comprise a mathematical description of conditions or relations between or among one or more variables. For a map, for example, such variables may comprise a location of a point (e.g. corner or any other part of a building, room, point of an intersection, and so on), length of a building or a path, distance between two structures or elements, and so on.

In one implementation, constraints may be inferred from a conceptual map. For example, conditions or relations between or among topological elements in a conceptual map may, in some cases, be used to infer one or more constraints associated with the topological elements. For example, a relation between a location of a corner of a building and an intersection of two walkways may allow for an inference of a constraint that sets the corner of the building within a particular distance relative to a center of the intersection. Such a constraint, for example, may comprise an anchoring point constraint, though other types of constraints may be used in this or other situations. A strength of an inferred constraint may be “weak” for setting an anchoring point constraint, so that moving such a constraint in a map may incur relatively little penalty. On the other hand, strength of an inferred constraint may be “strong” for setting a collocation constraint, an adjacency constraint, or an alignment constraint, so that moving such a constraint in a map may incur relatively high penalty, though such moving is allowed. In contrast, strength of constraints inferred from ground truth measurements may be set as “required”, so that there is a high likelihood that such constraints may be followed and satisfied.

In an implementation, a conceptual map of a complex of building structures or rooms and their surroundings, for example, may comprise an artist rendering or other imprecise rendering of a mapping of the complex. In such a case, for example, relational positioning of elements of a complex depicted in a conceptual map may be a primary concern whereas dimensions or distances (if present in the conceptual map) between or among features of the elements may be merely a secondary concern. In other words, a conceptual map may show a number of buildings, rooms, or features and their positions relative to one another. Approximate dimensions of buildings, rooms, or features may or may not be indicated in a conceptual map. However, a conceptual map may fall short of showing relatively accurate dimensions, let alone any dimensions, of buildings, rooms, or features. For example, a conceptual map may correctly depict relational positioning among its elements, so that, for example, a particular building or room may be shown to be bordered partially by a walkway, a portion of another building or room, and a road. However, dimensions (e.g., distances, separations, sizes, lengths, and so on) of these and other features of the elements may not be depicted in a conceptual map. On the other hand, if such dimensions are depicted in a conceptual map they may be inaccurate.

In one implementation, a conceptual map may comprise a vector graphics file format used to store digital images in a memory. For example, a conceptual map may comprise a collection of bits in any of a number of image file formats, such as a Joint Photographic Experts Group (JPEG) format, Tagged Image File Format (TIFF), or Graphics Interchange Format (GIF), just to name a few examples. In a particular implementation, a conceptual map may include metadata associated with a vector graphics file. For example, an illustration may comprise drawings of an artist's conception of a map (e.g., shapes or relative sizes of rooms, buildings, or areas) while metadata may comprise dimensions, a map legend, labeling, or identifiers for the conceptual map, though claimed subject matter is not limited in this respect.

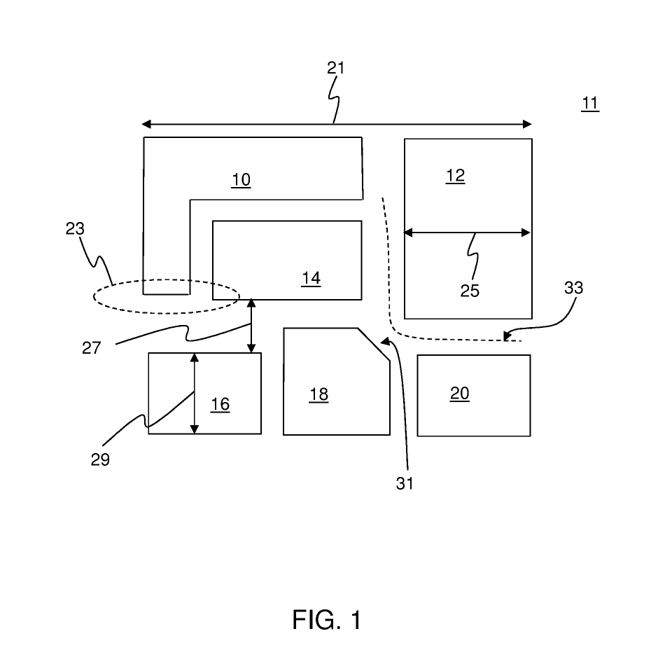

For example, FIG. 1 shows an implementation of a conceptual map 11, which depicts buildings 10, 12, 14, 16, 18, and 20. As indicated above, a conceptual map may show features without dimensions or scale, or such features may show features with merely approximate dimensions to a scale. For example, dimension 21 of a width of buildings or rooms 10, 12, and a walkway in between may be approximately shown in conceptual map 11 or not shown at all. Similarly, a width 25 of building or room 12 may or may not be shown in conceptual map 11. Conceptual map 11 may depict a distance 27 between buildings or rooms 14 and 16 inaccurately or disproportionately, with respect to other features depicted in the conceptual map. As a consequence of such inaccuracy or disproportion, width 29 of building or room 16 may be depicted inaccurately by conceptual map 11, for example. Additionally, alignment of buildings or other elements depicted in a conceptual map may be only approximate or inaccurate in a conceptual map. For example, conceptual map 11 may depict edges of neighboring buildings or rooms 10 and 14 as being offset from one another, as shown by dashed oval 23. However, such building or room edges may, in fact, actually be aligned with one another. As another example, building or room 18 may be shown to have an angular portion having an angle 31. Conceptual map 11 may show angle 31 to be different from the actual value by several degrees or more. Using a map having such distortions or inaccuracies may affect navigation in and among elements shown by the conceptual map 11. For example, characteristics (e.g., shape, distance) of path 33 may be measured from dimensions of features of elements (e.g., angle 31, widths 21, 25, and 27), if such dimensions are shown in conceptual map 11. Accordingly, it may be desirable for a user to obtain one or more dimensions of physical elements depicted in a conceptual map if such dimensions are not depicted in the conceptual map. If a conceptual map includes dimensions, however, it may be desirable for a user to obtain such dimensions having improved accuracy or corrected values, as discussed below.

In some implementations, a number of techniques may be used to improve or correct a conceptual map. Here, improving or correcting a conceptual map may include a process of determining values of dimensions or distances of features of one or more elements represented in the conceptual map. In one implementation, improving or correcting a conceptual map may include correcting a set of dimensions that relate two or more topological elements of a conceptual map to one another. Such correcting may provide a modified map having corrected dimensions. Improving or correcting a conceptual map may involve altering or adjusting dimensions or a layout of the conceptual map in view of determined values of such dimensions or distances. For example, an improved or corrected conceptual map may depict features of elements such as buildings, rooms, or walkways that are shifted in position relative to one another in comparison to an original conceptual map. Also, an improved or corrected conceptual map may depict values of dimensions of such features that may not have been present in an original conceptual map. For example, a conceptual map may depict merely two rooms separated by a walkway, whereas an improved conceptual map may depict a width of the walkway or dimensions of the rooms. In another example, dimensions of elements depicted by a conceptual map may be altered or adjusted or reapportioned according to a particular scale, which may be determined for the conceptual map using ground-truth measurements with any of a number of processes, described below.

In one implementation, a map may be developed based, at least in part, on a conceptual map using ground truth measurements. For example, inaccuracies, distortions, errors, or lack of dimensions of elements depicted in a conceptual map may be corrected or dealt with using a set of ground truth measurements. Accordingly, a relatively accurate and informative map may be developed as a consequence of correcting an original conceptual map. As described below in further detail, ground truth measurements of an area may comprise measurements collected in or about the area as opposed to remotely collecting measurements. For example, a pedometer operating on a person walking around an area may provide ground truth measurements (e.g., ranges) for that area. In contrast, for example, measurements (e.g., ranges) provided by a satellite positioning system or by using signal strength or round trip delay from access points need not comprise ground truth measurements. In one implementation, ground truth measurements may be descriptive of features of elements depicted in a conceptual map that are correct or precise to a tolerance expected for a map scale used in the map.

A process of improving or correcting a conceptual map may include identifying constraints based, at least in part, on layout or topology of the conceptual map. For example, relative positions of features of elements (e.g., rooms, buildings, walkways, and so on) depicted in a conceptual map may provide a number of topological constraints. In a particular example, a building “A” may be depicted in a conceptual map to be wider than both neighboring buildings “B” and “C”. Such a depiction may provide a topological constraint relating widths of buildings “A”, “B”, and “C” that may be applied (possibly with additional topological constraints), as described below, in determining particular dimensions of the buildings. Topological constraints may be intrinsic to a conceptual map, wherein topological relations among elements depicted in the conceptual map itself may provide sufficient information to develop such topological constraints. On the other hand, additional topological constraints may be developed based, at least in part, on ground truth measurement of features of physical elements depicted or represented in a conceptual map. For example, such ground truth measurements may be used to check dimensions or lengths of features of elements depicted in or represented by a conceptual map (e.g., paths in a building, widths of corridors to determining separation among blocks, and so on). One or more sets of topological constraints may be applied using any of a number of constraint solver techniques to obtain corrected positions or dimensions of features of map elements, which may subsequently be used to develop a new, improved or corrected map, for example. One particular example of a constraint solver technique may include Cassowary Linear Arithmetic Constraint Solving Algorithm (developed by Greg J. Badros, Alan Borning, and Peter J. Stuckey, published in ACM Transactions on Computer Human Interaction, Vol. 8 No. 4, December 2001, pages 267-306). Of course, such details of a process of correcting a conceptual map are merely examples, and claimed subject matter is not so limited.

One particular technique to improve or correct a conceptual map may apply odometry comprising inertial sensors to measure dimensions of physical features of elements that are depicted in the conceptual map (e.g., length of a hallway, building). For example, odometer or accelerometer measurements may be used to infer dimensions of topological elements in a conceptual map. In one implementation, an MS may measure odometer readings performed by the MS and combine the readings with locations of turns or other changes in direction detected by an accelerometer in the MS. For example, such turns may comprise a change in direction of a path from one room to another room or to a hallway. Combining odometer readings with detected locations of turns may allow for determining a length or dimension of a portion of topological elements, such as a side of a building, a position of a doorway, a room, a hallway, and so on. Whether a room or a hallway is being detected, for example, may be determined based, at least in part, on how far an MS (performing the measurements) travels after turning, and distances traveled between subsequent turns. A relatively high number of turns within a particular location may suggest boundaries of a particular room, for example.

In another implementation, a user may walk along a predefined path shown in a conceptual map while wearing one or more sensors (e.g., accelerometer or pedometer on a shoe or waist). Sensor measurement signals, such as from a pedometer, may be processed to measure distances. Sensor measurement signals, such as from an accelerometer, may be processed to measure changes in direction (e.g., angular changes) of a pathway, for example. These measurements may subsequently be used to improve or correct a conceptual map. In particular, such measurements may be used as constraints and applied to a set of equations relating elements depicted in a conceptual map which, if solved, may provide values of dimensions of features of the elements in an improved or corrected map. Measurements via odometry comprise one example of “ground-truth” measurements, as mentioned above, to refer to such measurements or other information comprising true (e.g., accurate or precise) dimensions of features of elements depicted in a conceptual map.

Another particular technique to improve or correct a conceptual map may utilize signals from environmental sensors in lieu of or in addition to odometry for determining constraints to be applied in improving or correcting a conceptual map. Measurements via environmental sensors may comprise ground-truth measurements and may be used to correlate signals from access points, for example, with locations or features depicted in a conceptual map. Such environmental sensors may include, for example, infrared sensors/range detectors, microphone, camera, temperature sensor, just to provide a few examples. In one implementation, an environmental sensor may comprise a thermometer to provide temperature measurements to determine if a region (where the thermometer is located) is indoors or outdoors. For example, a relatively low temperature measurement may indicate an outdoor region, whereas a relatively high temperature measurement may indicate an indoor region. In another implementation, an environmental sensor may comprise a microphone to provide audio measurements to determine if a region (where the microphone is located) is indoors, outdoors, near a street, or in a room, for example. A relatively low audio signal may indicate a region in a room, whereas a relatively high audio signal may indicate a region near a street. In yet another implementation, an environmental sensor may comprise a light sensor to provide spectral or intensity measurements of light to determine if a region (where the light sensor is located) is indoors or outdoors, for example. A spectral profile similar to that of the sun, for example, may indicate a region that is outdoors, whereas a spectral profile similar to that of incandescent or fluorescent lights may indicate a region that is indoors. Of course, details of environmental sensors are merely examples, and claimed subject matter is not so limited.

In one implementation, information provided by a web mapping service application may be used during a process of improving or correcting a conceptual map or to provide ground-truth measurements. For example, a web mapping service may provide distances between or among features of elements depicted in a conceptual map or may provide locations (e.g., latitude/longitude, or positions relative to a particular point of interest) of the elements. A few particular examples may include Google Maps provided by Google, Inc., Mountain View, Calif.; Mapquest, Lancaster, Pa.; and Bing Maps by Microsoft, Inc., Bellevue, Wash. Using Google maps or other internet map source, for example, an outline of a building or complex of buildings may be found. Constraints used to improve or correct a conceptual map may be based, at least in part, on such an outline. For example, a web mapping service may provide one or more distances between or among features of elements depicted in a conceptual map. Such one or more distances may be used as constraints that may be applied, as explained below, to determine other distances between or among features of elements depicted in the conceptual map.

In one implementation, a method performed at a mobile station may comprise receiving electronic signals representing a conceptual map of a navigable area and applying one or more constraints to the conceptual map to provide a corrected map. A conceptual map may comprise two or more topological features. Accordingly, applying one or more constraints may alter a relationship between or among such two or more topological features in a corrected conceptual map. As mentioned above, and discussed in further detail below, one or more constraints may comprise inferences based, at least in part, on inertial sensor measurements, odometry, environmental sensor measurements, or a web mapping service application. Applying one or more constraints to a conceptual map to provide a corrected map may involve altering or adjusting dimensions of one or more map elements depicted in the conceptual map while maintaining topological relationships between or among the one or more map elements. Of course, such details of a process of correcting a conceptual map are merely examples, and claimed subject matter is not so limited.

In an implementation, an apparatus for performing a method for improving or correcting a conceptual map may comprise a memory and one or more processing units to receive a conceptual map of a navigable area and to apply one or more constraints to the conceptual map to provide a corrected map. In addition to constraints provided by arrangements of elements depicted in a conceptual map, information obtained from ground truth collection, e.g. actual measurements from inertial or environmental sensors, may provide additional constraints. For example, size constraints may comprise an absolute dimension or relative sizes. Amount of overlap of two or more map elements may also comprise a constraint. One or more constraints may be determined from ground truth measurements by inertial sensors, such as accelerometers, compasses, or gyroscopes. In another example, one or more constraints may be determined from inferences based, at least in part, on environmental sensor measurements, or a pedometer. Accordingly, a conceptual map may be improved or corrected (e.g., relationships between or among different topological components may be determined or adjusted) in an improved or corrected map by solving sets of equations including such constraints. For example, applying a set of constraints may lead to adjusting dimensions of or related to features of elements depicted in a conceptual map to produce a corrected map. Of course, such details of an apparatus for correcting a conceptual map are merely examples, and claimed subject matter is not so limited.

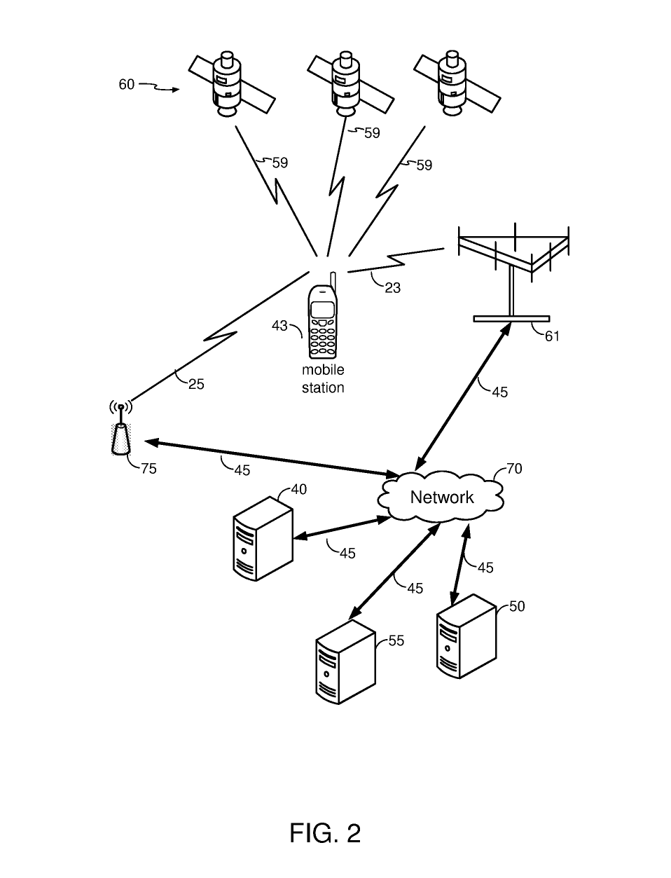

In certain implementations, as shown in FIG. 2, an MS 43 may receive or acquire SPS signals 59 from SPS satellites 60. In some embodiments, SPS satellites 60 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS′) such as, for example, WAAS, EGNOS, QZSS, just to name a few examples.

In addition, the MS 43 may transmit radio signals to, and receive radio signals from, a wireless communication network. In one example, MS may communicate with a cellular communication network by transmitting wireless signals to, or receiving wireless signals from, a base station transceiver 61 over a wireless communication link 63. Similarly, MS 43 may transmit wireless signals to, or receiving wireless signals from a local transceiver 75 over a wireless communication link 65.

In a particular implementation, local transceiver 75 may be configured to communicate with MS 43 at a shorter range over wireless communication link 65 than at a range enabled by base station transceiver 61 over wireless communication link 63. For example, local transceiver 75 may be positioned in an indoor environment. Local transceiver 75 may provide access to a wireless local area network (WLAN, e.g., IEEE Std. 802.11 network) or wireless personal area network (WPAN, e.g., Bluetooth network). In another example implementation, local transceiver 75 may comprise a femto cell transceiver capable of facilitating communication on link 65 according to a cellular communication protocol. Of course, it should be understood that these are merely examples of networks that may communicate with an MS over a wireless link, and claimed subject matter is not limited in this respect.

In a particular implementation, base station transceiver 61 and local transceiver 75 may communicate with servers 40, 50 and 55 over a network 70 through links 45. Here, network 70 may comprise any combination of wired or wireless links. In a particular implementation, network 70 may comprise Internet Protocol (IP) infrastructure capable of facilitating communication between MS 43 and servers 40, 50 or 55 through local transceiver 75 or base station transceiver 50. In another implementation, network 70 may comprising cellular communication network infrastructure such as, for example, a base station controller or master switching center to facilitate mobile cellular communication with MS 43.

In particular implementations, and as discussed below, MS 43 may have circuitry and processing resources capable of computing a position fix or estimated location of MS 43. For example, MS 43 may compute a position fix based, at least in part, on pseudorange measurements to four or more SPS satellites 60. Here, MS 43 may compute such pseudorange measurements based, at least in part, on pseudonoise code phase detections in signals 59 acquired from four or more SPS satellites 60. In particular implementations, MS 43 may receive from server 40, 50 or 55 positioning assistance data to aid in the acquisition of signals 59 transmitted by SPS satellites 60 including, for example, almanac, ephemeris data, Doppler search windows, just to name a few examples.

In other implementations, MS 43 may obtain a position fix by processing signals received from terrestrial transmitters fixed at known locations (e.g., such as base station transceiver 61) using any one of several techniques such as, for example, advanced forward trilateration (AFLT) and/or observed time difference of arrival (OTDOA). In these particular techniques, a range from MS 43 may be measured to three or more of such terrestrial transmitters fixed at known locations based, at least in part, on pilot signals transmitted by the transmitters fixed at known locations and received at MS 43. Here, servers 40, 50 or 55 may be capable of providing positioning assistance data to MS 43 including, for example, locations and identities of terrestrial transmitters to facilitate positioning techniques such as AFLT and OTDOA. For example, servers 40, 50 or 55 may include a base station almanac (B5A) which indicates locations and identities of cellular base stations in a particular region or regions. [Does the B5A provide any other pertinent information?]

Here in particular environments such as indoor environments or urban canyons, MS 43 may not be capable of acquiring signals 59 from a sufficient number of SPS satellites 60 or perform AFLT or OTDOA to compute a position fix. Alternatively, MS 43 may be capable of computing a position fix based, at least in part, on signals acquired from local transmitters (e.g., WLAN access points positioned at known locations). For example, MSs can typically obtain a position fix by measuring ranges to three or more indoor terrestrial wireless access points which are positioned at known locations. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT). In alternative implementations, MS 43 may obtain an indoor position fix by applying characteristics of acquired signals to a radio “heatmap” indicating expected RSSI and/or RTT signatures at particular locations in an indoor area.

In particular implementations, MS 43 may receive positioning assistance data for indoor positioning operations from servers 40, 50 or 55. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio heatmaps, locations and identities of transmitters, routeability graphs, just to name a few examples. Other assistance data received by the MS may include, for example, local maps of indoor areas for display or to aid in navigation. Such a map, which may comprise a conceptual map in some cases, for example, may be provided to MS 43 as MS 43 enters a particular indoor area. Such a map may show indoor features such as doors, hallways, entry ways, walls, etc., points of interest such as bathrooms, pay phones, room names, stores, etc. By obtaining and displaying such a map, an MS may overlay a current location of the MS (and user) over the displayed map to provide the user with additional context.

In one implementation, a routeability graph and/or digital map may assist MS 43 in defining feasible areas for navigation within an indoor area and subject to physical obstructions (e.g., walls) and passage ways (e.g., doorways in walls). Here, by defining feasible areas for navigation, MS 43 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, MS 43 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of MS 43.

According to an embodiment, MS 43 may access indoor navigation assistance data through servers 40, 50 or 55 by, for example, requesting the indoor assistance data through selection of a universal resource locator (URL). In particular implementations, servers 40, 50 or 55 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at MS 43 and data transmission resources may make receipt of indoor navigation assistance data for all areas served by servers 40, 50 or 55 impractical or infeasible, a request for indoor navigation assistance data from MS 43 may indicate a rough or course estimate of a location of MS 43. MS 43 may then be provided indoor navigation assistance data covering areas including and/or proximate to the rough or course estimate of the location of MS 43.

In one particular implementation, a request for indoor navigation assistance data from MS 43 may specify a location context identifier (LCI). Such an LCI may be associated with a locally defined area such as, for example, a particular floor of a building or other indoor area which is not mapped according to a global coordinate system. In one example server architecture, upon entry of an area, MS 43 may request a first server, such as server 40, to provide one or more LCIs covering the area or adjacent areas. Here, the request from the MS 43 may include a rough location of MS 43 such that the requested server may associate the rough location with areas covered by known LCIs, and then transmit those LCIs to MS 43. MS 43 may then use the received LCIs in subsequent messages with a different server, such as server 50, for obtaining navigation assistance relevant to an area identifiable by one or more of the LCIs as discussed above (e.g., digital maps, locations and identifies of beacon transmitters, radio heatmaps or routeability graphs).

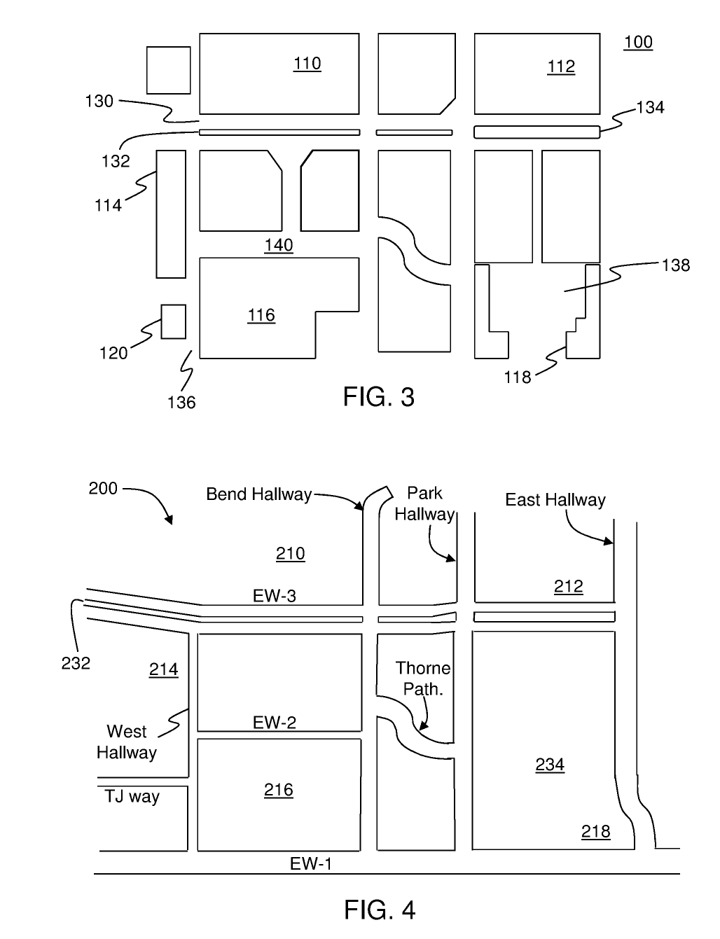

FIG. 3 shows a conceptual map 100 of a building complex, such as a shopping mall, for example, according to an implementation. Conceptual map 100 may show a number of buildings, a few which are labeled in FIG. 3 as 110, 112, 114, 116, and 118. Conceptual map 100 may also include any number of other types of structures or elements, such as doors, walkways, hallways, entry ways, walls, points of interest (POI) such as bathrooms, pay phones, room names, stores, and so on. For example, conceptual map 100 includes a number of elements, a few which are labeled in FIG. 3: roads 130 and 136, walkway 140, road partitions 132 and 134, and parking area 138. As indicated above, a conceptual map may correctly (albeit possibly with inaccurate or out-of-proportion dimensions) depict relational positioning among its elements, so that, for example, the physical structure of building 116 is truly bordered partially by the physical structures of walkway 140, buildings 114 and 120, and road 136. However, dimensions (e.g., distances, separations, sizes, lengths, and so on) of elements, which may be depicted in a conceptual map as an associated metadata file, for example, may be inaccurate. Further, dimensions associated with some features of map elements may be depicted in a conceptual map while dimensions associated with other features of map elements may be absent. For example, conceptual map 100 may not specify a width of walkway 140. Or, if such a width were specified, such as in a metadata file associated with conceptual map 100, it may be incorrect (e.g., by a few meters). As another example, conceptual map 100 may depict right-hand edges of buildings 114 and 120 aligned with one another, while such an alignment of the physical structures of buildings 114 and 120 may not truly be in alignment. Other examples where conceptual map 100 may fall short of accurately depicting dimensions or relative positioning of its elements: parking area 138 may be shown having an inaccurate size or shape; road partition 134 may be shown to be too wide; an outline of the building complex represented by corner buildings 110, 112, 116, and 118 may be shown to have an inaccurate size or shape; and so on. As mentioned above, dimensions of features of elements depicted in a conceptual map, which may comprise vector graphics, may be included in a metadata file associated with the conceptual map.

FIG. 4 shows a portion of a map 200 mapping an area including a shopping mall, such as that depicted in FIG. 3 for example, according to an implementation. Map 200 may comprise a map showing an indoor or an outdoor area, for example. Map 200 may include dimensions of one or more features of elements provided by a web mapping service application, such as Google Maps or Mapquest, for example, though claimed subject matter is not so limited. Such dimensions provided by a web mapping service may be considered to be more accurate dimensions provided by a conceptual map (via metadata, for example). Map 200 may include a number of elements common with elements depicted in conceptual map 100. For example, road or walkway partition 132 may be shown in map 200 as partition 232. Such a web mapping service application may provide an outline of a building, a complex of buildings, rooms, or a group of halls or rooms by showing positions of neighboring streets, paths, or hallways, among other things. Thus, an outline of the shopping mall (which may be indoors or outdoors, for example) shown in conceptual map 100 may comprise hallway “EW-3”, West Hallway, hallway “EW-1”, and East Hallway, for example. As another example, an outline of building or room 116 may be at least partially shown by block 216, bordered by West Hallway, EW-1 and hallway “EW-2”, and Bend Hallway. Such outlines may be used to develop topological constraints to correct conceptual map 100. Further, a layout of streets or halls, including interior streets or halls (e.g., TJ Way, Thorne path, EW-2, and so on) shown by map 200 may be used to develop additional topological constraints to further correct or modify a layout of conceptual map 100, as explained below. Of course, such details of a map or a conceptual map are merely examples, and claimed subject matter is not so limited.

In an example implementation, the layout of a conceptual map may be adjusted (e.g., corrected) by solving a set of constraints (e.g., topological constraints). Any of a number of ground-truth measurements may be used to develop such constraints. For example, as mentioned above, one technique to improve or correct a conceptual map may utilize odometry comprising sensors to measure dimensions of physical features of elements identified in a conceptual map. Such measured dimensions may subsequently be used to develop a set of constraints to be applied in a process of correcting features of a conceptual map, for example. Constraints may also be developed by utilizing measurements from environmental sensors. Yet another approach to developing constraints may involve a web mapping service application, as described above. In addition to such approaches for developing sets of constraints, a topological relation among different components depicted in a conceptual map may also lead to a set of (intrinsic) constraints. For example, such topological relations of a map layout may be extracted from a conceptual map. In one implementation, topological relations may be automatically extracted or developed into constraints without any user action. For example, a processor may execute an application to extract such topological relations or developing such constraints from a conceptual map comprising vector graphics, such as SVG. In a particular implementation, topological relations comprising edges or corners of map elements depicted in a conceptual map may be identified by an executed application. In such a case, a processor may automatically (e.g., involving no user action) detect or measure positional relationships among edges or corners of map elements represented by a bitmap. For example, distances between or among such portions of elements may be determined. Intrinsic constraints may subsequently be based, at least in part, on such determined distances.

A topological relationship between or among topological elements depicted in a conceptual map may be characterized by one or more constraint types. For example, anchoring constraints may be used to characterize a point anchored to its current location. Collocation constraints may comprise two or more points that remain anchored with respect to one another, separated by a known distance. Adjacency constraints may comprise a constraint established between two map elements to ensure that one stays above, below, to the left of, or to the right of the other, for example. Such two map elements may or may not overlap by a known or unknown amount. Alignment constraints may comprise two or more elements that remain lined up as either of the elements are moved about. It should be understood, however, that these are merely examples of constraints that may be applied to features depicted in a conceptual map, and claimed subject matter is not so limited.

Constraints may be characterized as to whether the constraints comprise an equality expression or an inequality expression, as explained in further detail below. The term “equality expression” means an equation or relation involving constraints wherein one side of the equation is equal to the other side of the equation within a tolerance. In other words, both sides of an equation need not be exactly equal to satisfy the equation, but may different from one another within some amount or tolerance. The term “inequality expression” means a relation involving constraints wherein one side of the relation is greater than or less than the other side of the relation by at least a threshold value. Anchoring constraints may comprise equality constraints, collocation constraints may comprise equality constraints, and adjacency constraints may comprise non-equality constraints. Of course, such details of constraints applied to map correction are merely examples, and claimed subject matter is not so limited.

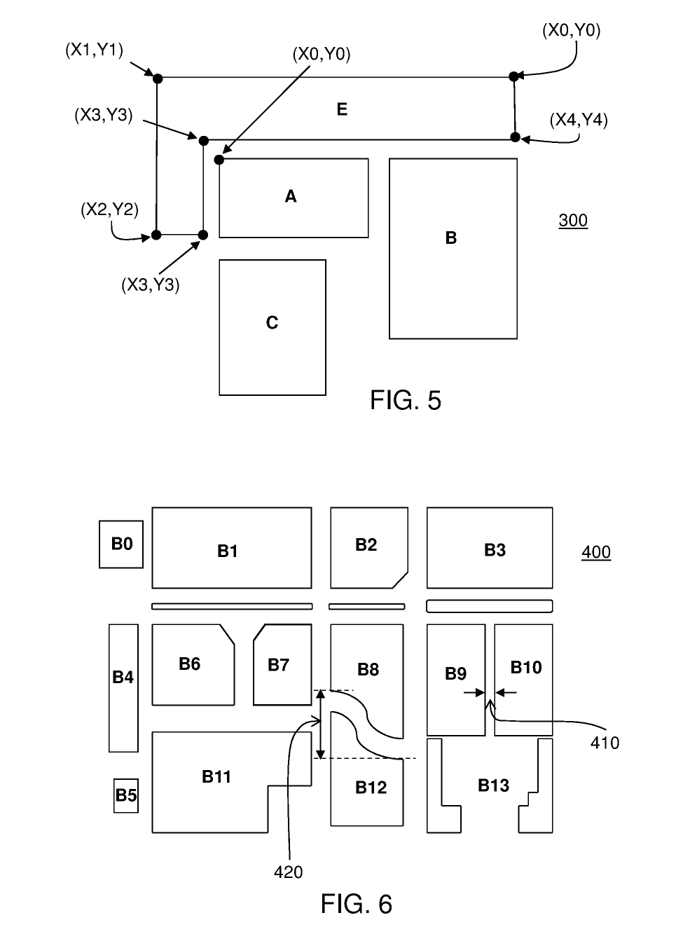

FIG. 5 shows a constraint model 300 comprising a building map of a portion of a building complex, according to an implementation. Model 300 may be used as an illustrative example to show particular techniques for developing constraints. For example, blocks A, B, C, and E may individually represent elements depicted in a conceptual map, such as buildings separated by various roads or walkways. Of course, blocks A, B, C, and D may represent any of a number of other element types, such as, but not limited to doors, hallways, entry ways, walls, or POIs, for example. Relative positioning of blocks A, B, C, and D may be described in terms of left, right, top, bottom, upper, lower, above, and below, and coordinate locations of the blocks may be described in terms of a coordinate system. For example, (0,0) may represent upper left, though claimed subject matter is not limited in this respect. Accordingly, points (X₀, Y₀), (X₁, Y₁), (X₂, Y₂), (X₃, Y₃), and (X₄, Y₄) may describe locations of portions of individual blocks. In an implementation, relative positioning (e.g., as described by coordinate locations) of blocks may be preserved as required constraints during a process of map correction or adjustment. In one implementation, individual elements may comprise a number of attributes, such as a bounding rectangle or a bounding polygon. For example, a bounding rectangle may lead to constraints associating one block with another block, whereas a bounding polygon may lead to constraints on individual blocks, though claimed subject matter is not limited in this respect.

For example, topological constraints based, at least in part, on such bounding rectangles or bounding polygons may lead to a number of adjacency constraints. Again, as explained above, both sides of an equation need not be exactly equal to satisfy the equation, but may different from one another within some amount or tolerance (e.g., “equal” need not mean “exactly equal”). For constraints associated with block A: left edges of blocks A and C are aligned, leading to constraint A_{left}=C_{left}; top edges of blocks A and B are aligned, leading to constraint Aₜₒₚ=Bₜₒₚ; block A is to the left of block B so that a right edge of block A is to the left of a left edge of block B, leading to constraint A_{right}<B_{left}; bottom edges of blocks A and E are aligned, leading to constraint A_{bottom}=E_{bottom}; block A is above block C so that a bottom edge of block A is above a top edge of block C, leading to constraint A_{bottom}<Cₜₒₚ; a particular portion of block A is displaced by “dx” to the right of and “dy” below a particular portion of block E, leading to constraints A_{X(0)}=E_{X(3)}+dx and A_{Y(0)}=E_{Y(3)}+dy. Similarly, additional constraints may be described for blocks B, C, and E. For example, right edges of blocks B and E are aligned, leading to constraint B_{right}=E_{right}.

Bounding polygons may lead to additional constraints on individual blocks. For example, a particular portion of block E may be at a same coordinate location as another particular portion of block E, leading to constraints E_{Y(0)}=E_{Y(1)} and E_{Y(3)}=E_{Y(4)}.

FIG. 6 shows constraint elements depicted in a conceptual map 400 of a shopping mall, according to an implementation. Map 400 may be similar to conceptual map 100 shown in FIG. 3. For example, blocks B0, B1, B2 . . . B13 may individually represent elements depicted in a conceptual map, such as buildings separated by various roads or walkways. Of course, the blocks may represent any of a number of other element types, such as, but not limited to doors, hallways, entry ways, walls, or POIs, for example. Similar to techniques described above for constraint model 300, relative positioning of the blocks may be described in terms of left, right, upper, lower, above, and below, and coordinate locations of the blocks may be described in terms of a coordinate system. In an implementation, relative positioning (e.g., as described by coordinate locations) of blocks may be preserved as required constraints during a process of map correction or adjustment. In one implementation, such constraints may be realized by examining associations between or among blocks in conceptual map 400. As mentioned above, such constraints may include anchoring constraints, collocation constraints, or adjacency constraints, among others. For example, anchoring constraints may be associated with original positions of blocks, and may be established as weak constraints in a Cassowary constraint solve process. Locations described by weak constraints, for example, may be moved in order to satisfy other required constraints.

Collocation constraints, for example, may describe a constant gap or contact edge among blocks in map 400. For example, upper edges of block B13 may be collocated with bottom edges of blocks B9 and B10, leading to constraint B13ₜₒₚ=B9_{bottom}=B10_{bottom}. Gap 410 between blocks B9 and B10 may lead to constraint B9_{right}+width of gap 410=B10_{left}. Overlap 420 among blocks B8 and B12 may lead to constraint B12ₜₒₚ−B8_{bottom}=width of overlap 420. Similarly, additional constraints may be written for remaining blocks.

Adjacency constraints, for example, may describe associations among edges of blocks. For example, right edges of blocks B0, B4, and B5 are aligned, leading to constraint B0_{right}=B4_{right}=B5_{right}. Block B1 is to the right of block B0 so that a right edge of block B0 is to the left of a left edge of block B1, leading to constraint B0_{right}<B1_{left}. Block B2 is to the right of block B1 so that a right edge of block B1 is to the left of a left edge of block B2, leading to constraint B1_{right}<B2_{left}. Similarly, additional constraints may be written for remaining blocks.

Alignment constraints, for example, may also describe associations among edges of blocks. For example, bottom edges of blocks B1, B2, and B3 are aligned, leading to constraint B1_{bottom}=B2_{bottom}=B3_{bottom}. Top edges of blocks B4, B6, B7, B8, B9, and B10 are aligned, leading to constraint B4ₜₒₚ=B6ₜₒₚ=B7ₜₒₚ=B8ₜₒₚ=B9ₜₒₚ=B10ₜₒₚ. Left edges of blocks B1, B6, and B11 are aligned, leading to constraint B1_{left}=B6_{left}=B11_{left}. Similarly, additional constraints may be written for remaining blocks.

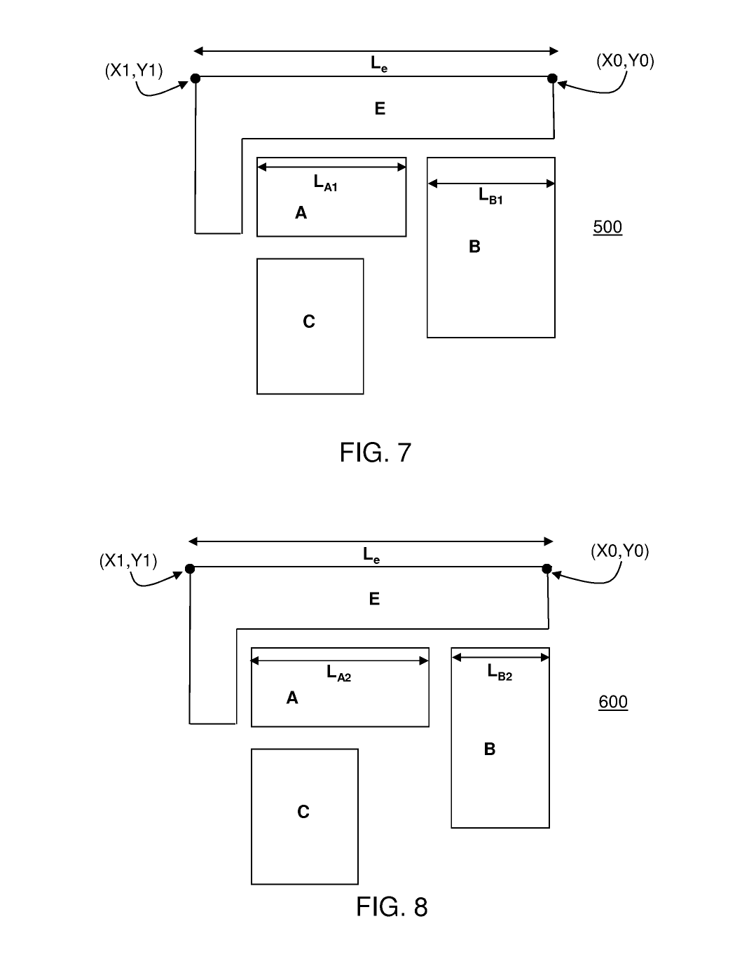

FIG. 7 shows a constraint model 500 of a portion of a building complex, according to an implementation. Model 500 may be similar to model 300 shown in FIG. 5, for example. Blocks A, B, C, and E may individually represent elements depicted in a conceptual map, such as buildings separated by various roads or walkways. Of course, the blocks may represent any of a number of other element types, such as, but not limited to doors, hallways, entry ways, walls, or POIs, for example. Relative positioning of the blocks may be described in terms of a coordinate system. For example, (0,0) may represent upper left, though claimed subject matter is not limited in this respect. Accordingly, points (X₀, Y₀) and (X₁, Y₁) may described locations on individual blocks, namely block E in model 500.

As mentioned above, a conceptual map may be corrected by a process that utilizes odometry to obtain ground truths regarding features of physical elements represented in the conceptual map. For example, inertial sensors may be used to measure dimensions of features of physical elements such as a length of a hallway, building, or street. Such inertial sensors, for example, may be held by a user walking or riding along a path to provide sensor measurement data that may be processed to estimate distances as well as angles along the path. Such distances, applied as a set of constraints, may be used to correct a conceptual map. Ground truths measured by inertial sensors may lead to a set of equality constraints. For example, the width of block E may be measured as Lₑ, so that an associated constraint may be expressed as Eₓ₀−Eₓ₁=Lₑ. As another example, the width L_{A1} of block A may be measured to be twice the width L_{B1} of block B so that an associated constraint may be expressed as L_{A1}=2*L_{B1}.

FIG. 8 shows a constraint model 600 that includes corrections or adjustments to constraint model 500. In other words, applying a set of constraints to model 500 may lead to model 600. In the example above, a ground truth measurement led to the constraint that width of block A is twice the width of block B (e.g., L_{A2}=2*L_{B2}). Applying the constraint may lead to a relative widening of block A and a relative narrowing of block B in constraint model 600. Other adjustments (e.g., changes to sizes, shapes, or positions of blocks A, B, C, and E) may be based, at least in part, on additional constraints. For sake of example and illustration, the evolution of model 500 to 600 by a process of applying constraints may be similar in process to that of correcting a conceptual map. For example, if model 500 comprises a conceptual map, then applying constraints in a correction process may lead to model 600 comprising a corrected map. Of course, such details of constraint models are merely examples, and claimed subject matter is not so limited.

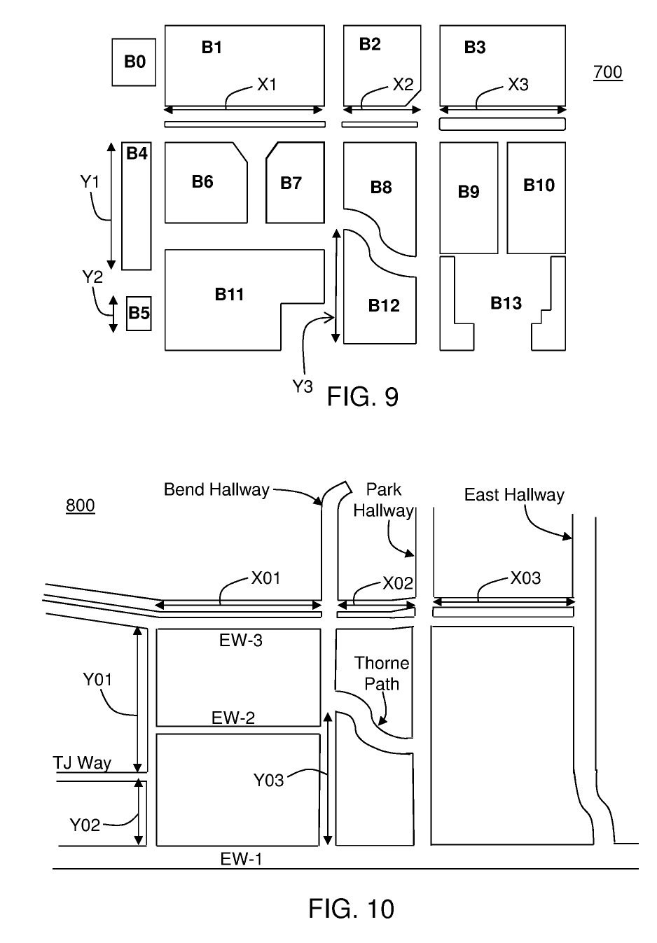

FIG. 9 shows constraint elements depicted in a conceptual map 700 of a shopping mall, according to another implementation. Map 700 may be similar to conceptual map 400 shown in FIG. 6. For example, blocks B0, B1, B2 . . . B13 may individually represent elements depicted in a conceptual map, such as buildings separated by various roads or walkways. As discussed above, relative positioning of blocks may be preserved as required constraints during a process of map correction or adjustment. In one implementation, such constraints may be realized by examining associations between or among blocks in conceptual map 700. As mentioned above, such constraints may include anchoring constraints, collocation constraints, or adjacency constraints, among others. In another implementation, additional constraints may be realized by measuring ground truths using, for example, inertial sensors. Thus, for example, inertial sensors may be used to provide a ground truth measurement of widths X1, X2, X3, Y1, Y2, or Y3 of blocks B1, B2, B3, B4, B5, and B12, respectively. As described below, such ground truth measurements may be applied as a set of constraints in a process of correcting conceptual map 700.

FIG. 10 shows constraint elements in a portion of a map 800 in an area including that of conceptual map 700, shown in FIG. 9. Map 800 may be provided by a mapping service application, such as Google Maps, for example. For a particular example, map 800 may include ground truth measurements of widths X01, X02, X03, Y01, Y02, and Y03 of blocks B1, B2, B3, B4, B5, and B12, respectively. A set of constraints may be realized by comparing ground truth measurements of map 800 (e.g., from a mapping service application) to ground truth measurements of map 700 (e.g., by inertial sensors). For example, one set of constraints may be expressed as X1/X01=X2/X02=X3/X03. Another set of constraints may be expressed as Y1/Y01=Y2/Y02 and X2/Yi=X02/Y0i, and so on. Of course, such details of maps and conceptual maps are merely examples, and claimed subject matter is not so limited.

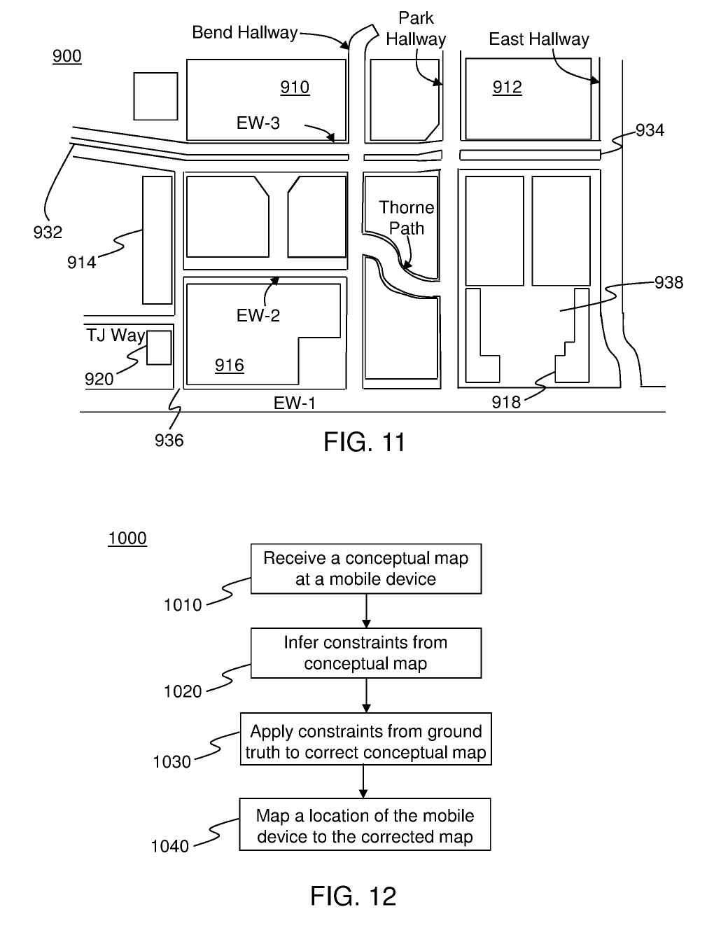

FIG. 11 shows a corrected map 900 of a shopping mall superposed with map 200, according to an implementation. Map 900 may cover a region similar to that of conceptual map 100 shown in FIG. 3, for example. Map 900 may include corrections or adjustments to conceptual map 100. In other words, applying a set of constraints, as discussed above, to conceptual map 100 may lead to map 900. In an implementation, a consequence of correcting conceptual map 100 may be that resulting map 900, having improved accuracy, may be aligned with block outlines of map 200 (which may be provided by a mapping service application, for example). In an example correction to conceptual map 100, corrected building 910 may comprise conceptual building 110 having an adjusted outline position or size to correctly align with EW-3. In another example correction to conceptual map 100, corrected building or room 912 may comprise conceptual building or room 112 having an adjusted outline position or size to correctly align with EW-3 and East Hallway. In yet another example correction to conceptual map 100, Thorne Path may be adjusted from a conceptual shape shown in conceptual map 100 to a corrected shape shown in map 900.

Accordingly, map 900 may comprise a corrected map based, at least in part, on a particular set of constraints. In an implementation, map 900 may be correctable to further accuracy. For example, as more constraints are considered in a map correction process, dimensions or positions of segments of map elements may become more accurate. Thus, uncertainty in dimensions/positions of map elements may depend, at least in part, on number of constraints.

FIG. 12 is a flow diagram illustrating a process 1000 for producing a corrected map from a conceptual map, according to an implementation. Such a process may be performed at an MS, for example, though claimed subject matter is not so limited. On the other hand, however, such a process may be performed at a server located at a land-based station in communication with an MS, for example. At block 1010, an MS may receive a conceptual map of a navigable area. In a particular example, an MS may receive electronic signals representative of a conceptual map. At block 1020, constraints may be inferred from the conceptual map. For example, mathematical descriptions of conditions between or among topological elements (e.g., buildings, corners of buildings, walkways, roads, hallways, room, auditoriums, and so on) of the conceptual map may be inferred based, at least in part, on relative positions, dimensions, and so on of the topological elements. At block 1030 one or more constraints from ground truth measurements may be applied to elements depicted in the conceptual map to correct the conceptual map. For example, elements depicted in the conceptual map may be used to develop a set of intrinsic constraints. On the other hand, ground truth measurements made by any number of types of sensors may be used to develop additional constraints. At block 1040, a corrected map may be used to map the location of the MS. Accordingly, the correctly mapped location of the MS may be offset compared to a location of the MS relative to the conceptual map. Of course, such details of process 1000 are merely examples, and claimed subject matter is not so limited.

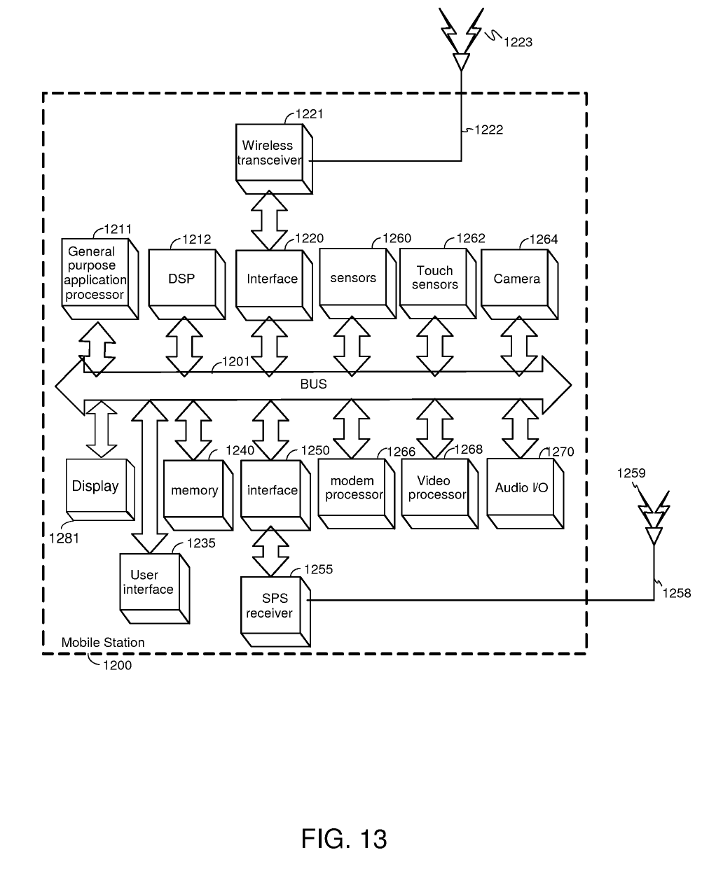

FIG. 13 is a schematic diagram of an MS according to an embodiment. MS 1200 may comprise one or more features of MS 43 shown in FIG. 2, for example. In certain embodiments, MS 1200 may also comprise a wireless transceiver 1221 which is capable of transmitting and receiving wireless signals 1223 via an antenna 1222 over a wireless communication network, such as over a wireless communication link 63, shown in FIG. 2, for example. Wireless transceiver 1221 may be connected to bus 1201 by a wireless transceiver bus interface 1220. Wireless transceiver bus interface 1220 may, in some embodiments be at least partially integrated with wireless transceiver 1221. Some embodiments may include multiple wireless transceivers 1221 and wireless antennas 1222 to enable transmitting and/or receiving signals according to a corresponding multiple wireless communication standards such as, for example, WiFi, CDMA, WCDMA, LTE and Bluetooth, just to name a few examples.

MS 1200 may also comprise SPS receiver 1255 capable of receiving and acquiring SPS signals 1259 via SPS antenna 1258. SPS receiver 1255 may also process, in whole or in part, acquired SPS signals 1259 for estimating a location of MS 1000. In some embodiments, general-purpose processor(s) 1211, memory 1240, DSP(s) 1212 and/or specialized processors (not shown) may also be utilized to process acquired SPS signals, in whole or in part, and/or calculate an estimated location of MS 1200, in conjunction with SPS receiver 1255. Storage of SPS or other signals for use in performing positioning operations may be performed in memory 1240 or registers (not shown).

Also shown in FIG. 13, MS 1200 may comprise digital signal processor(s) (DSP(s)) 1212 connected to the bus 1201 by a bus interface 1210, general-purpose processor(s) 1211 connected to the bus 1201 by a bus interface 1210 and memory 1240. Bus interface 1210 may be integrated with the DSP(s) 1212, general-purpose processor(s) 1211 and memory 1240. In various embodiments, functions or processes, such as process 1000 shown in FIG. 12, for example, may be performed in response to execution of one or more machine-readable instructions stored in memory 1240 such as on a computer-readable storage medium, such as RAM, ROM, FLASH, or disc drive, just to name a few example. The one or more instructions may be executable by general-purpose processor(s) 1211, specialized processors, or DSP(s) 1212. In one implementation, for example, one or more machine-readable instructions stored in memory 1240 may be executable by a processor(s) 1211 to: receive a conceptual map of a navigable area, wherein the conceptual map may include two or more topological elements being related to one another in the conceptual map by a first set of dimensions; apply one or more ground truth measurements or topological constraints to the first set of dimensions of the conceptual map to provide a modified map having corrected dimensions; and map an estimated location of a mobile station to the modified map. Memory 1240 may comprise a non-transitory processor-readable memory and/or a computer-readable memory that stores software code (programming code, instructions, etc.) that are executable by processor(s) 1211 and/or DSP(s) 1212 to perform functions described herein.

Also shown in FIG. 13, a user interface 1235 may comprise any one of several devices such as, for example, a speaker, microphone, display device, vibration device, keyboard, touch screen, just to name a few examples. In a particular implementation, user interface 1235 may enable a user to interact with one or more applications hosted on MS 1200. For example, devices of user interface 1235 may store analog or digital signals on memory 1240 to be further processed by DSP(s) 1212 or general purpose processor 1211 in response to action from a user. Similarly, applications hosted on MS 1200 may store analog or digital signals on memory 1240 to present an output signal to a user. In another implementation, MS 1200 may optionally include a dedicated audio input/output (I/O) device 1270 comprising, for example, a dedicated speaker, microphone, digital to analog circuitry, analog to digital circuitry, amplifiers and/or gain control. It should be understood, however, that this is merely an example of how an audio I/O may be implemented in an MS, and that claimed subject matter is not limited in this respect. In another implementation, MS 1200 may comprise touch sensors 1262 responsive to touching or pressure on a keyboard or touch screen device.

MS 1200 may also comprise a dedicated camera device 1264 for capturing still or moving imagery. Camera device 1264 may be used as an environmental sensor, for example, as described above. Camera device 1264 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1211 or DSP(s) 1212. Alternatively, a dedicated video processor 1268 may perform conditioning, encoding, compression or manipulation of signals representing captured images. Additionally, video processor 1268 may decode/decompress stored image data for presentation on a display device 1281 on MS 1200. Such a display device may also be used to display conceptual maps or corrected maps.

MS 1200 may also comprise sensors 1260 coupled to bus 1201 which may include, for example, inertial sensors and environment sensors that may be used for ground-truth measurements, as described above. Inertial sensors of sensors 1260 may comprise, for example accelerometers (e.g., collectively responding to acceleration of MS 1200 in three dimensions), one or more gyroscopes or one or more magnetometers (e.g., to support one or more compass applications). Environment sensors of MS 1200 may comprise, for example, temperature sensors, barometric pressure sensors, ambient light sensors, camera imagers, microphones, just to name few examples. Sensors 1260 may generate analog or digital signals that may be stored in memory 1240 and processed by DPS(s) or general purpose processor 1211 in support of one or more applications such as, for example, applications directed to positioning or navigation operations.

In a particular implementation, MS 1200 may comprise a dedicated modem processor 1266 capable of performing baseband processing of signals received and downconverted at wireless transceiver 1221 or SPS receiver 1255. Similarly, modem processor 1266 may perform baseband processing of signals to be upconverted for transmission by wireless transceiver 1221. In alternative implementations, instead of having a dedicated modem processor, baseband processing may be performed by a general purpose processor or DSP (e.g., general purpose/application processor 1211 or DSP(s) 1212). It should be understood, however, that these are merely examples of structures that may perform baseband processing, and that claimed subject matter is not limited in this respect.

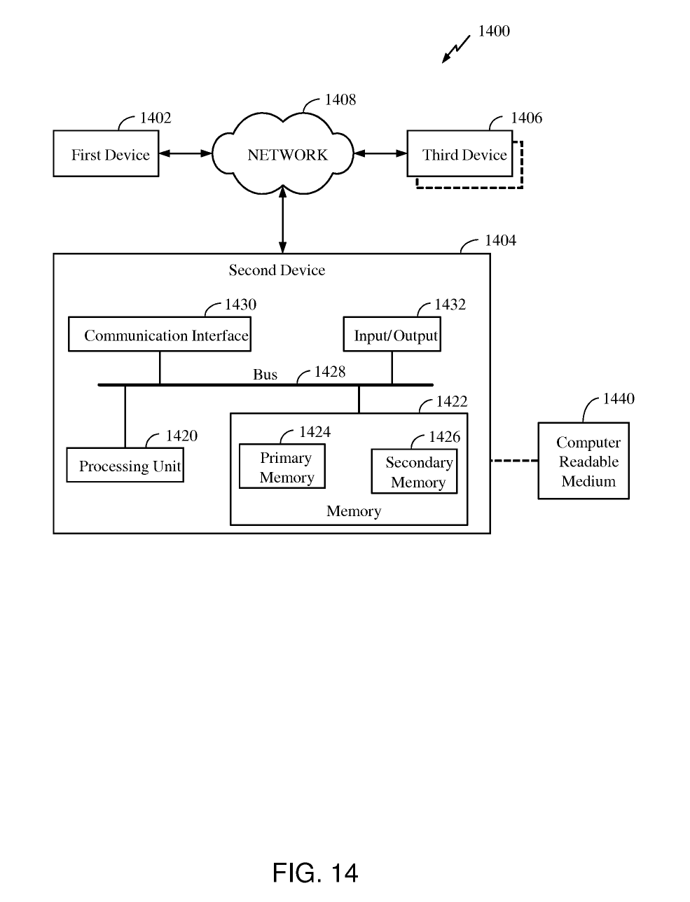

FIG. 14 is a schematic diagram illustrating an example system 1400 that may include one or more devices configurable to implement techniques or processes, such as process 1000 described above, for example, in connection with FIG. 2. System 1400 may include, for example, a first device 1402, a second device 1404, and a third device 1406, which may be operatively coupled together through a wireless communications network 1408. In an aspect, first device 1402 may comprise a server capable of providing positioning assistance data such as, for example, a base station almanac. First device 1402 may also comprise a server capable of providing an LCI to a requesting MS based, at least in part, on a rough estimate of a location of the requesting MS. First device 1402 may also comprise a server capable of providing indoor positioning assistance data relevant to a location of an LCI specified in a request from an MS. Second and third devices 1404 and 1406 may comprise MSs, in an aspect. Also, in an aspect, wireless communications network 1408 may comprise one or more wireless access points, for example. However, claimed subject matter is not limited in scope in these respects.

First device 1402, second device 1404 and third device 1406, as shown in FIG. 14, may be representative of any device, appliance or machine that may be configurable to exchange data over wireless communications network 1408. By way of example but not limitation, any of first device 1402, second device 1404, or third device 1406 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1402, 1404, and 1406, respectively, may comprise one or more of a base station almanac server, a base station, or an MS in accordance with the examples described herein.

Similarly, wireless communications network 1408, as shown in FIG. 14, is representative of one or more communication links, processes, or resources configurable to support the exchange of data between at least two of first device 1402, second device 1404, and third device 1406. By way of example but not limitation, wireless communications network 1408 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1406, there may be additional like devices operatively coupled to wireless communications network 1408.

It is recognized that all or part of the various devices and networks shown in system 1400, and the processes and methods as further described herein, may be implemented using or otherwise including hardware, firmware, software, or any combination thereof.

Thus, by way of example but not limitation, second device 1404 may include at least one processing unit 1420 that is operatively coupled to a memory 1422 through a bus 1428. In one implementation, for example, one or more machine-readable instructions stored in memory 1422 may be executable by processing unit 1420 to: receive a conceptual map of a navigable area, wherein the conceptual map may include two or more topological elements being related to one another in the conceptual map by a first set of dimensions; apply one or more ground truth measurements or topological constraints to the first set of dimensions of the conceptual map to provide a modified map having corrected dimensions; and map an estimated location of a mobile station to the modified map

Processing unit 1420 is representative of one or more circuits configurable to perform at least a portion of a data computing procedure or process. By way of example but not limitation, processing unit 1420 may include one or more processors, controllers, microprocessors, microcontrollers, application specific integrated circuits, digital signal processors, programmable logic devices, field programmable gate arrays, and the like, or any combination thereof.

Memory 1422 is representative of any data storage mechanism. Memory 1422 may include, for example, a primary memory 1424 or a secondary memory 1426. Primary memory 1424 may include, for example, a random access memory, read only memory, etc. While illustrated in this example as being separate from processing unit 1420, it should be understood that all or part of primary memory 1424 may be provided within or otherwise co-located/coupled with processing unit 1420.

Secondary memory 1426 may include, for example, the same or similar type of memory as primary memory or one or more data storage devices or systems, such as, for example, a disk drive, an optical disc drive, a tape drive, a solid state memory drive, etc. In certain implementations, secondary memory 1426 may be operatively receptive of, or otherwise configurable to couple to, a computer-readable medium 1440. Computer-readable medium 1440 may include, for example, any non-transitory medium that can carry or make accessible data, code or instructions for one or more of the devices in system 1400. Computer-readable medium 1440 may also be referred to as a storage medium.

Second device 1404 may include, for example, a communication interface 1030 that provides for or otherwise supports the operative coupling of second device 1404 to at least wireless communications network 1408. By way of example but not limitation, communication interface 1430 may include a network interface device or card, a modem, a router, a switch, a transceiver, and the like.

Second device 1404 may include, for example, an input/output device 1432. Input/output device 1432 is representative of one or more devices or features that may be configurable to accept or otherwise introduce human or machine inputs, or one or more devices or features that may be configurable to deliver or otherwise provide for human or machine outputs. By way of example but not limitation, input/output device 1432 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more MSs may communicate with a femtocell via a code division multiple access (“CDMA”) cellular communication protocol, for example, and the femtocell may provide the MS access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising, at a mobile station:
receiving a conceptual map of a navigable area, said conceptual map including two or more topological elements being related to one another in said conceptual map by a first set of dimensions;
applying one or more ground truth measurements or topological constraints to said first set of dimensions of said conceptual map to provide a modified map having corrected dimensions; and
mapping an estimated location of the mobile station to said modified map.

2. The method of claim 1, wherein said applying said one or more ground truth measurements or topological constraints further comprises altering said first set of dimensions.

3. The method of claim 2, wherein said one or more topological constraints comprise at least one of an anchoring constraint, a collocation constraint, an adjacency constraint, or an alignment constraint.

4. The method of claim 1, wherein said one or more topological constraints further comprise inferences based, at least in part, on inertial sensor measurements.

5. The method of claim 1, wherein said one or more topological constraints further comprise inferences based, at least in part, on environmental sensor measurements.

6. The method of claim 5, wherein said environmental sensor measurements are based, at least in part, on an inertial sensor.

7. The method of claim 5, wherein said environmental sensor measurements are based, at least in part, on a pedometer.

8. The method of claim 1, wherein said one or more topological constraints further comprise inferences based, at least in part, on a web mapping service application.

9. The method of claim 1, wherein said applying one or more topological constraints to said first set of dimensions of said conceptual map to provide said modified map further comprises adjusting dimensions of one or more map elements depicted in said conceptual map while maintaining topological relations among said one or more map elements depicted in said conceptual map.

10. The method of claim 1, further comprising applying additional topological constraints to further modify said modified map.

11. The method of claim 1, further comprising automatically detecting or measuring positional relationships among edges or corners of map elements depicted in said conceptual map.

12. An apparatus comprising:
means for receiving a conceptual map of a navigable area, said conceptual map including two or more topological elements being related to one another in said conceptual map by a first set of dimensions;
means for applying one or more ground truth measurements or topological constraints to said first set of dimensions of said conceptual map to provide a modified map having corrected dimensions; and
means for mapping an estimated location of a mobile station to said modified map.

13. The apparatus of claim 12, wherein said means for applying said one or more ground truth measurements or topological constraints further comprises means for altering said first set of dimensions.

14. The apparatus of claim 13, wherein said one or more topological constraints comprise at least one of an anchoring constraint, a collocation constraint, an adjacency constraint, or an alignment constraint.

15. The apparatus of claim 12, wherein said one or more topological constraints further comprise inferences based, at least in part, on inertial sensor measurements.

16. The apparatus of claim 12, wherein said one or more topological constraints further comprise inferences based, at least in part, on environmental sensor measurements.

17. The apparatus of claim 16, wherein said environmental sensor measurements are based, at least in part, on an inertial sensor.

18. The apparatus of claim 16, wherein said environmental sensor measurements are based, at least in part, on a pedometer.

19. The apparatus of claim 12, wherein said one or more topological constraints further comprise inferences based, at least in part, on a web mapping service application.

20. The apparatus of claim 12, wherein said means for applying one or more topological constraints to said first set of dimensions of said conceptual map to provide said modified map further comprises means for adjusting dimensions of one or more map elements depicted in said conceptual map while maintaining topological relations among said one or more map elements depicted in said conceptual map.

21. The apparatus of claim 12, further comprising means for applying additional topological constraints to further modify said modified map.

22. An apparatus comprising:
memory; and
one or more processing units to:
receive a conceptual map of a navigable area, said conceptual map including two or more topological elements being related to one another in said conceptual map by a first set of dimensions;
apply one or more ground truth measurements or topological constraints to said first set of dimensions of said conceptual map to provide a modified map having corrected dimensions; and
map an estimated location of a mobile station to said modified map.

23. The apparatus of claim 22, wherein said applying said one or more ground truth measurements or topological constraints further comprises altering said first set of dimensions.

24. The apparatus of claim 23, wherein said one or more topological constraints comprise at least one of an anchoring constraint, a collocation constraint, an adjacency constraint, or an alignment constraint.

25. The apparatus of claim 22, wherein said one or more topological constraints further comprise inferences based, at least in part, on inertial sensor measurements.

26. The apparatus of claim 22, wherein said one or more topological constraints further comprise inferences based, at least in part, on environmental sensor measurements.

27. The apparatus of claim 26, wherein said environmental sensor measurements are based, at least in part, on an inertial sensor.

28. The apparatus of claim 26, wherein said environmental sensor measurements are based, at least in part, on a pedometer.

29. The apparatus of claim 22, wherein said one or more topological constraints further comprise inferences based, at least in part, on a web mapping service application.

30. The apparatus of claim 22, wherein said applying one or more topological constraints to said first set of dimensions of said conceptual map to provide said modified map further comprises adjusting dimensions of one or more map elements depicted in said conceptual map while maintaining topological relations among said one or more map elements depicted in said conceptual map.

31. The apparatus of claim 22, said one or more processing units to further apply additional constraints to further modify said modified map.

32. An article comprising: a non-transitory storage medium comprising machine-readable instructions stored thereon that are executable by a special purpose computing device to:
receive a conceptual map of a navigable area, said conceptual map including two or more topological elements being related to one another in said conceptual map by a first set of dimensions;
apply one or more ground truth measurements or topological constraints to said first set of dimensions of said conceptual map to provide a modified map having corrected dimensions; and
map an estimated location of a mobile station to said modified map.

33. The article of claim 32, said applying said one or more ground truth measurements or topological constraints further comprises altering said first set of dimensions.

34. The article of claim 33, wherein said one or more topological constraints comprise at least one of an anchoring constraint, a collocation constraint, an adjacency constraint, or an alignment constraint.

35. The article of claim 32, wherein said one or more topological constraints further comprise inferences based, at least in part, on inertial sensor measurements.

36. The article of claim 32, wherein said one or more topological constraints further comprise inferences based, at least in part, on environmental sensor measurements.

37. The article of claim 36, wherein said environmental sensor measurements are based, at least in part, on an inertial sensor.

38. The article of claim 36, wherein said environmental sensor measurements are based, at least in part, on a pedometer.

39. The article of claim 32, wherein said one or more topological constraints further comprise inferences based, at least in part, on a web mapping service application.

40. The article of claim 32, wherein said applying one or more topological constraints to said first set of dimensions of said conceptual map to provide said modified map further comprises adjusting dimensions of one or more map elements depicted in said conceptual map while maintaining topological relations among said one or more map elements depicted in said conceptual map.

41. The article of claim 32, further comprising applying additional constraints to further modify said modified map.
